(19) United States
(12) Patent Application Publication
(10) Pub. No.: US 2024/0198268 A1
(43) Pub. Date: Jun. 20, 2024

(54) PLASMA FILTER

(71) Applicant: COWAY Co., Ltd., Gongju-si (KR)

(72) Inventors: Seung Ki KIM, Seoul (KR); Bu Gwan CHUN, Seoul (KR); Yoon Hyuck CHOI, Seoul (KR); Ju Hyun BAEK, Seoul (KR); Chan Jung PARK, Seoul (KR)

(73) Assignee: COWAY Co., Ltd., Gongju-si (KR)

(21) Appl. No.: 18/507,151

(22) Filed: Nov. 13, 2023

(30) Foreign Application Priority Data
Dec. 20, 2022 (KR) 10-2022-0179420

(51) Int. Cl. B01D 46/00

(52) U.S. Cl. CPC B01D 46/0028; B01D 46/0005; B01D 2259/818

(57) ABSTRACT

A plasma filter includes: a bar assembly including a bar extending in a longitudinal direction; a wire installed spaced apart from the bar to generate plasma between the bar and the wire when power is applied thereto; and a frame assembly on which the bar and the wire are supported. A posture fixture is formed in the frame assembly to fix one or more of both end portions of the bar to prevent a posture of the bar from changing.

### TECHNICAL FIELD

The present disclosure relates to a plasma filter.

### BACKGROUND

In general, a plasma filter, which is built into an air purifier or the like, can sterilize harmful germs and bacteria in the air and remove fine dust by generating plasma using resistive discharge. Such a plasma filter is configured to generate plasma by discharging of a steel wire through electrical interaction with an earth member.

The present applicant's Korean Patent Application Publication No. 10-2005-0099165 entitled “Resistor discharge plasma filter and air purifier using the same” (Patent Document 1) discloses a steel rod made of metal for grounding an electric field, and a steel mesh with wires made of metal disposed parallel to each other that generate plasma by being discharged by generating a potential difference with the steel rod. The plasma filter of Patent Document 1 is mounted in a housing such that both end portions of the steel rod are inserted into recesses of the housing.

However, the plasma filter of Patent Document 1 has a problem in that when both end portions of the steel rod are placed in the recesses of the housing, the posture of the steel rod may be changed due to vibration generated when the air purifier is operated. For example, the steel rod placed in the housing may be shaken up and down by the vibration of the air purifier, or the steel rod may be rotated in one direction or the other direction about the axis of the extension of the steel rod. When the steel rod is rotated, electrical discharge with the steel net may not occur properly, which may reduce plasma generation efficiency. Further, the steel rod of Patent Document 1 is formed in a cylindrical shape extending in a longitudinal direction thereof. In other words, the steel rod of Patent Document 1 is formed in a solid cylindrical shape made of metal. Accordingly, the weight of the steel rod itself is relatively increased, which increases the cost of manufacturing the steel rod.

Meanwhile, Korean Patent No. 10-0510833 entitled “plasma generator for air purification” (Patent Document 2) of the applicant PSM Co., Ltd. discloses a first electrode wire and a second electrode wire that are included in an air purifier and are connected to an external power source to generate plasma by receiving currents of opposite polarity. The first electrode wire and the second electrode wire of Patent Document 2 are arranged in a frame to cross each other perpendicularly, and the second electrode wire is placed in an electrode holding groove of a dielectric tube.

However, the plasma generator of Patent Document 2 also has a problem in that when the second electrode wire is placed in the electrode holding groove, the posture of the second electrode wire may be changed due to vibration generated when the air purifier is operated. For example, the second electrode wire is placed in the electrode holding groove having a groove shape with an open top. Accordingly, the second electrode wire may be separated from the upper side of the electrode holding groove due to external vibration, or may be rotated in one direction or the other direction about the axis of the extension of the second electrode wire. When the second electrode wire is rotated, electrical discharge with the first electrode wire may not occur properly, which may reduce plasma generation efficiency. In addition, the first electrode wire and the second electrode wire of Patent Document 2 are also formed in a cylindrical shape extending in the longitudinal direction. In other words, the first electrode wire and the second electrode wire of Patent Document 2 are formed in a solid cylindrical shape made of metal. Therefore, the weights of the first electrode wire and the second electrode wire themselves relatively increase, which increases the cost of manufacturing the first electrode wire and the second electrode wire.

Accordingly, there is a need for a plasma filter that can prevent the posture of a bar, such as a sus rod, from changing due to external vibration while it is placed on a frame. Further, there is a need for a plasma filter that can reduce the manufacturing cost of the bar.

### SUMMARY

In view of the above, the present disclosure provides a plasma filter that can increase plasma generation efficiency by preventing the posture of a bar from changing due to external vibration while the bar is placed on a frame.

Further, the present disclosure provides a plasma filter in which a bar can be easily inserted into a tube, which prevents damage to the tube and reduces the manufacturing cost of the bar.

In accordance with an embodiment of the present disclosure, there is provided a plasma filter including: a bar assembly including a bar extending in a longitudinal direction; a wire installed spaced apart from the bar to generate plasma between the bar and the wire when power is applied thereto; and a frame assembly on which the bar and the wire are supported, wherein a posture fixture is formed in the frame assembly to fix one or more of both end portions of the bar to prevent a posture of the bar from changing.

The bar may include a concave groove extending in the longitudinal direction and recessed from an outer peripheral surface of the bar toward a center of the bar, and the posture fixture may be inserted into the concave groove to be eccentric to the center of the bar.

The frame assembly may include: a main frame on which the bar and the wire are supported; and a bracket detachably coupled to the main frame and fixing the bar to the main frame, and the posture fixture may include: a first posture fixture formed on the main frame to fix one end portion of the bar; and a second posture fixture formed on the bracket to fix the other end portion of the bar.

The first posture fixture may be inserted into the groove at a position spaced apart from the center of the bar.

The second posture fixture may have a shape that protrudes downward from the bracket to engage with the other end of the bar.

The bar may include: a base portion; a side portion extending in a direction offset from the base portion to form the concave groove; and a connection portion connecting the base portion and the side portion, and the connection portion may be formed in a curved shape.

At least one of the base portion, the side portion, and the connection portion may be disposed at a position spaced apart from the center of the bar.

The main frame may include a bar seating portion on which one end portion of the bar is seated, and the bar seating portion may be arranged to be spaced a predetermined distance lower than the first posture fixture when the main frame is placed horizontally.

The bar assembly may further include a tube surrounding a portion of the bar, the main frame may further include a tube support portion for supporting the tube, and the tube support portion may be disposed lower than the bar seating portion when the main frame is placed horizontally.

The bar may include a plurality of bars and the wire includes a plurality of wires, and the plurality of bars and the plurality of wires may be arranged to alternate with each other when viewed from above.

According to one embodiment of the present disclosure, one or more posture fixtures that fix both end portions of the bar are formed in the frame assembly, so that the posture of the bar can be prevented from changing due to external vibration while the bar is placed in the frame assembly. Accordingly, the distance between the bar and the wire is maintained fixed, so that plasma generation efficiency can be increased.

In addition, the concave groove is formed in the bar, and the plurality of posture fixtures are inserted into the concave groove in both end portions of the bar, so that the bar can be stably fixed to the frame assembly.

Further, the bar has the curved connection portion that forms the concave groove, so that the bar can be easily inserted into the tube, which prevents the tube from being damaged when the bar is inserted into the tube.

Furthermore, the concave groove of the bar is formed to be spaced apart from the center of the bar, thereby reducing the material weight of the bar itself and reducing the manufacturing cost of the bar.

Moreover, by inserting the bar in the tube to be wrapped, the emission of ozone harmful to the human body, which may be generated from the bar when plasma is generated by electrical interaction between the bar and the wire, to the outside, can be reduced.

### BRIEF DESCRIPTION OF THE DRAWINGS

FIG. 1 is a perspective view of a plasma filter according to one embodiment of the present disclosure.

FIG. 2 is an exploded perspective view of the plasma filter of FIG. 1.

FIG. 3 is a diagram showing a bar assembly of FIG. 2.

FIGS. 4 and 5 are partial enlarged views showing one side of the bar assembly and a main frame of FIG. 2.

FIG. 6 is a cross-sectional view showing the bar assembly of FIG. 5 supported on the main frame.

FIGS. 7 and 8 are partial enlarged views showing the other side of the bar assembly and the main frame of FIG. 2.

FIG. 9 is a cross-sectional view showing the bar assembly of FIG. 8 supported on the main frame.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, or ‘supplied’ to another element, it should be understood that the element may be directly connected to, supported by, or, supplied to another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side and the lower side, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, the specific configuration of a plasma filter 1 according to one embodiment of the present disclosure will be described with reference to the drawings.

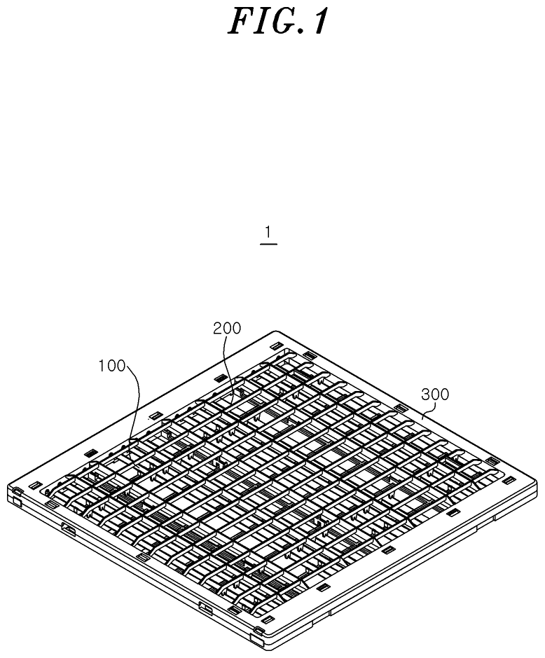

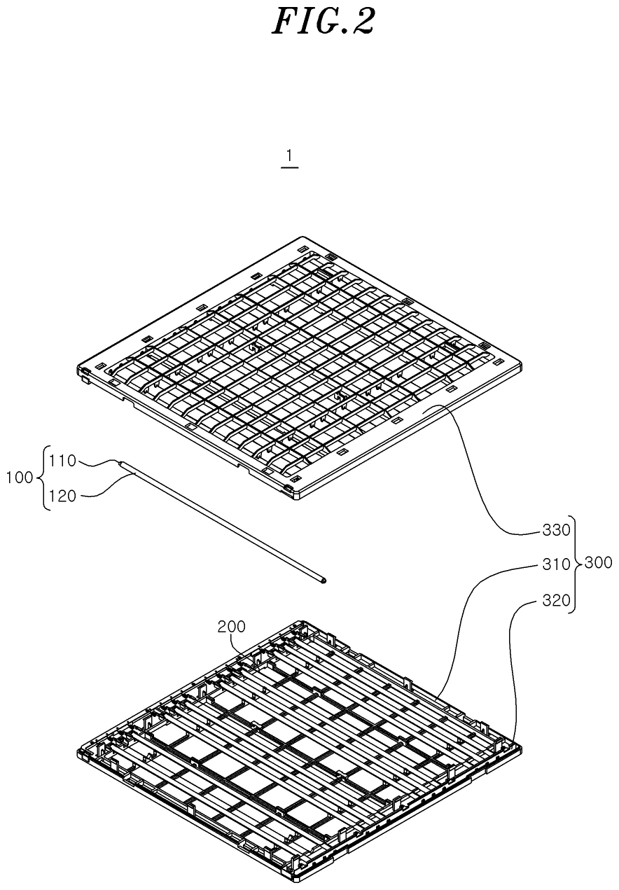

Referring to FIGS. 1 to 3, in the present embodiment, the plasma filter 1 can generate plasma to remove harmful fine dust or bacteria in the air. The plasma filter 1 may be detachably coupled to an air purifier or the like. The plasma filter 1 may include a bar assembly 100, a wire 200, and a frame assembly 300.

The bar assembly 100 may be grounded to the wire 200 to generate plasma in the wire 200. The bar assembly 100 may be supported on the frame assembly 300 to be adjacent to the wire 200. For example, a plurality of bar assemblies 100 may be provided, and the plurality of bar assemblies 100 may be arranged to alternate with a plurality of wires 200 in the frame assembly 300 when viewed from above. The bar assembly 100 may include a bar 110 and a tube 120.

The bar 110 may be grounded to the electric field generated from the wire 200. Plasma may be generated in the wire 200 by grounding the bar 110 to the electric field generated from the wire 200. The bar 110 may extend in a longitudinal direction thereof and may be made of steel material. Both end portions of the bar 110 are fixed by a first posture fixture 311 and a second posture fixture 321 of a main frame 310, which will be described later, of the frame assembly 300, so that the posture of the bar 110 placed on the main frame 310 of the frame assembly 300 can be prevented from changing. For example, the bar 110 may be prevented from rotating in one direction or the other direction about an axis of the extension of the bar 110 while being placed on the main frame 310. A concave groove 111 may be formed in the bar 110. Further, the bar 110 may include a base portion 112, a side portion 113, and a connection portion 114 that form the concave groove 111.

The concave groove 111 extends in the longitudinal direction of the bar 110 and may be recessed from an outer peripheral surface of the bar 110 toward a center of the bar 110. The first posture fixture 311 and the second posture fixture 321 may be inserted into the concave groove 111. For example, the first posture fixture 311 and the second posture fixture 321 are respectively inserted in the concave groove 111 formed in both end portions of the bar 110 to fix the bar 110, so that the posture of the bar 110 placed on the frame assembly 300 can be prevented from changing.

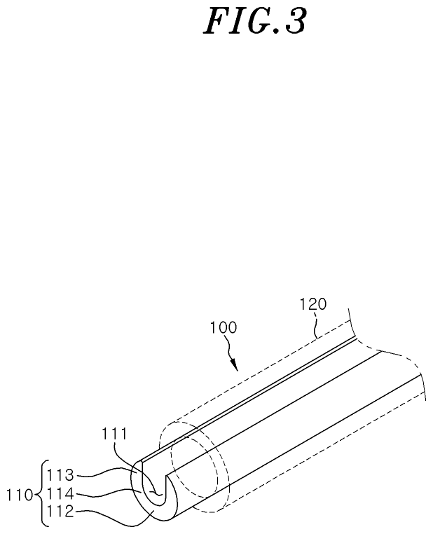

The base portion 112 may form one end (lower end in FIG. 3) of the bar 110. The base portion 112 may form the concave groove 111 together with the side portion 113 and the connection portion 114. The base portion 112 may be disposed at a position spaced apart from the center of the bar 110 to one side (lower side in FIG. 3). In other words, the base portion 112 may be disposed lower than the center of the bar 110.

The side portion 113 extends in a direction (upward direction in FIG. 3) from the base portion 112 and may form the concave groove 111 together with the base portion 112 and the connection portion 114. A plurality of side portions 113 may be provided, and the plurality of side portions 113 may extend upward from the base portion 112. The side portions 113 may be disposed at positions spaced apart from the center of the bar 110 in a horizontal direction. In other words, the plurality of side portions 113 may be arranged to be spaced apart from the center of the bar 110 on both sides.

The connection portion 114 may connect the base portion 112 and the side portion 113. In other words, the connection portion 114 may connect both ends of the base portion 112 and lower ends of the plurality of side portions 113. A plurality of connection portions 114 may be provided, and may be disposed at positions spaced apart from the center of the bar 110 downwardly and laterally. The connection portion 114 may be formed in a curved shape. When the connection portion 114 is formed in the curved shape, the bar 110 can be easily inserted into the tube 120, and the tube 120 can be prevented from being damaged in the process of inserting the bar 110 into the tube 120.

The tube 120 may surround a portion of the bar 110. For example, the tube 120 may surround the outer peripheral surface of the bar 110 excluding both end portions of the bar 110. By the tube 120 surrounding the outer peripheral surface of the bar 110, the emission of ozone harmful to the human body, which may be generated from the bar 110 when plasma is generated by the electrical interaction between the bar 110 and the wire 200, to the outside, can be reduced. Both end portions of the tube 120 may be supported on a tube support portion 313 of the frame assembly 300, which will be described later.

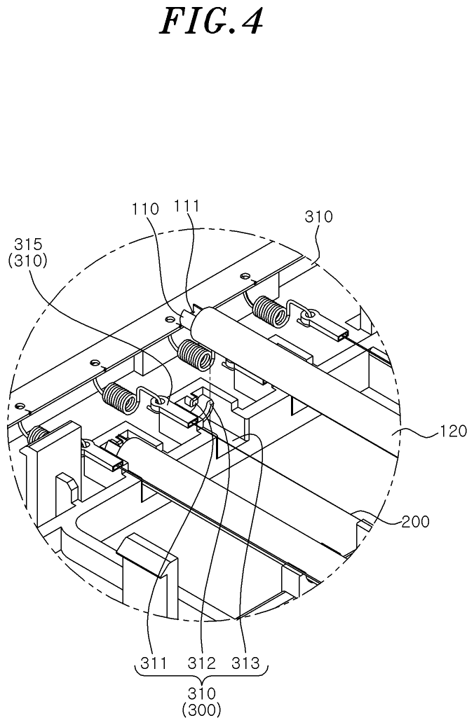

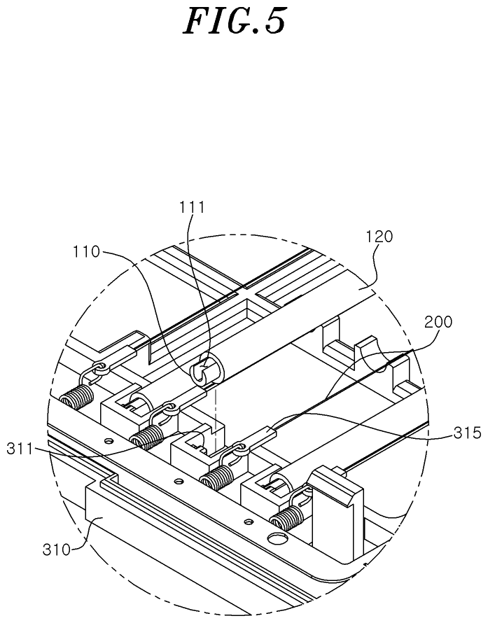

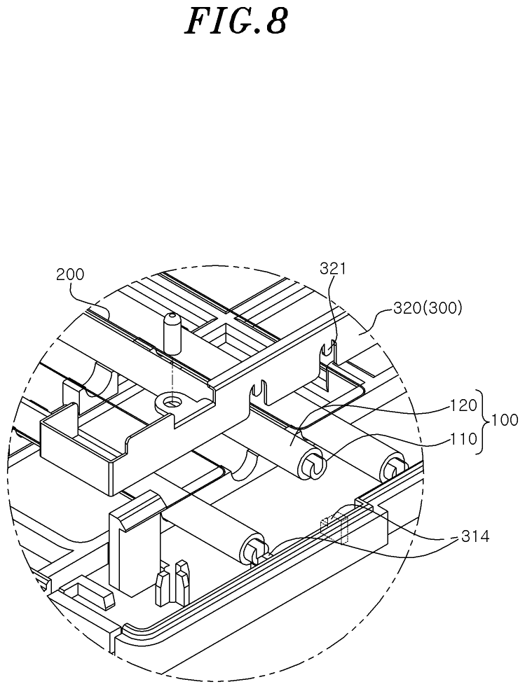

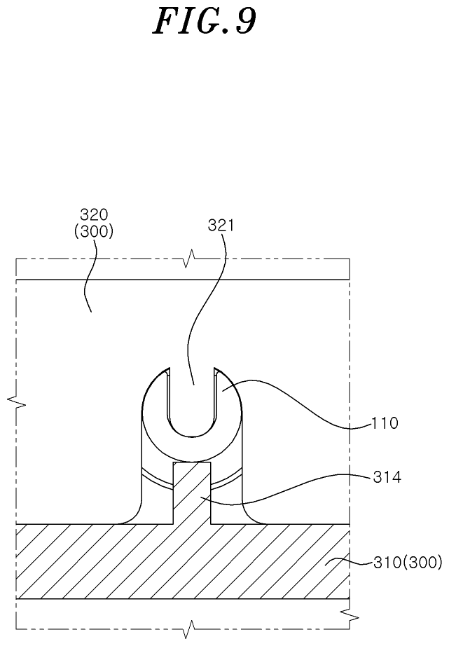

Referring to FIGS. 4 to 9, an electric field may be generated from the wire 200 when power is applied to the wire 200. When the electric field generated from the wire 200 is applied to the bar 110, the wire 200 may be discharged to generate plasma. The wire 200 may extend in a longitudinal direction and may be formed of a tungsten material. A plurality of wires 200 may be provided, and the plurality of wires 200 may be supported by a wire fixing portion 315 of the main frame 310, which will be described later. The plurality of wires 200 may be arranged to alternate with the plurality of bars 110 on the main frame 310 when viewed from above.

The frame assembly 300 may support the bar assembly 100 and the wire 200. The frame assembly 300 may include the main frame 310, a bracket 320, and a cover frame 330.

The main frame 310 may support the bar 110 and the wire 200. The main frame 310 may include a first posture fixture 311, a bar seating portion 312, a tube support portion 313, a bar support portion 314, and a wire fixing portion 315.

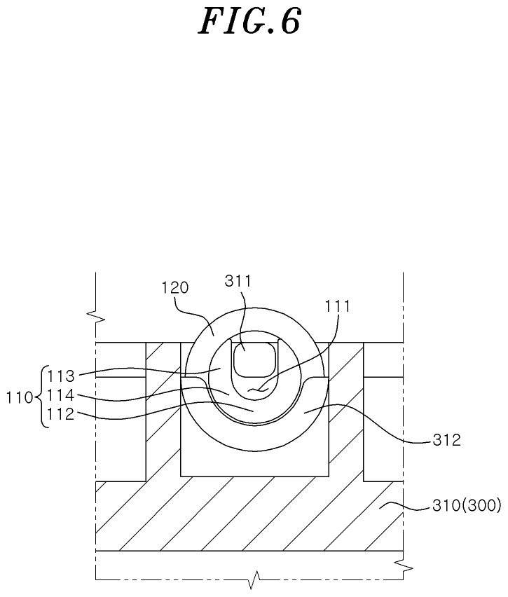

The first posture fixture 311 may fix one end portion of the bar 110 to prevent the posture of the bar 110 from changing. The first posture fixture 311 may be formed on one side (left side in FIG. 4) of the main frame 310. The first posture fixture 311 may be inserted into the concave groove 111 of the bar 110 to be eccentric to the center of the bar 110. For example, the first posture fixture 311 may be inserted into the concave groove 111 at a position spaced upward (upper side in FIG. 6) from the center of the bar 110.

One end portion of the bar 110 may be seated on the bar seating portion 312. For example, in a state in which the first posture fixture 311 is inserted into the concave groove 111 in one end portion of the bar 110, the one end portion of the bar 110 may be seated on the bar seating portion 312. In other words, one end portion of the bar 110 that is not surrounded by the tube 120 may be seated on the bar seating portion 312. The bar seating portion 312 may be disposed at a predetermined distance lower than the first posture fixture 311 when the main frame 310 is placed horizontally.

One end portion of the tube 120 may be supported on the tube support portion 313. For example, when the one end portion of the bar 110 is seated on the bar seating portion 312, the one end portion of the tube 120 may be supported on the tube support portion 313. The tube support portion 313 may be disposed lower than the bar seating portion 312 when the main frame 310 is placed horizontally.

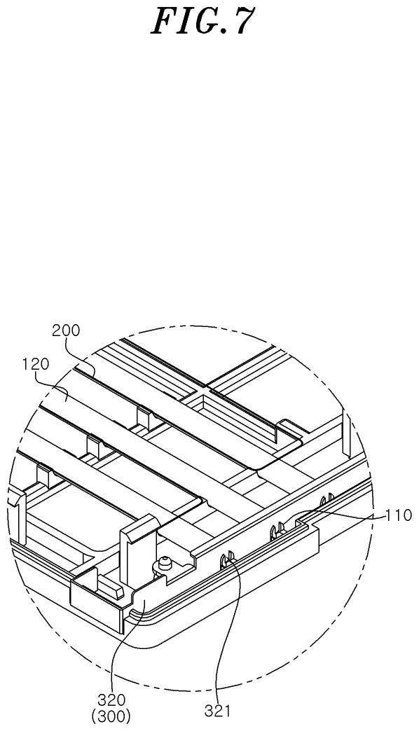

The bar support portion 314 may support the other end portion of the bar 110. The bar support portion 314 may be formed on the other side (right side in FIG. 7) of the main frame 310. The other end portion of the bar 110 may be supported on the bar support portion 314 in a state in which the second posture fixture 321, which will be described later, is inserted into the concave groove 111 of the other end of the bar 110. In other words, the other end portion of the bar 110 that is not wrapped by the tube 120 may be supported on the bar support portion 314.

The wire fixing portion 315 may fix the wire 200. A plurality of wire fixing portions 315 may be provided, and a plurality of wire fixing portions 315 may be spaced apart from each other at a predetermined distance on one side of the main frame 310. For example, one end of the wire 200 may be fixed to any one of the plurality of wire fixing portions 315, and the other end of the wire 200 may be fixed to another of the plurality of wire fixing portions 315 via the other side of the main frame 310. Meanwhile, the wire fixing portion 315 may be disposed on the main frame 310 through an elastic member such as a spring.

The bracket 320 may fix the other end portion of the bar 110 to the main frame 310 so that the other end portion of the bar 110 is supported by the main frame 310. Further, the bracket 320 can apply power supplied from the outside to the bar 110. The bracket 320 may be detachably coupled to the main frame 310. The second posture fixture 321 may be formed on the bracket 320.

The second posture fixture 321 may fix the other end portion of the bar 110 to the main frame 310 to prevent the posture of the bar 110 from changing. For example, the second posture fixture 321 may be inserted into the concave groove 111 formed in the other end portion of the bar 110 to fix the other end portion of the bar 110 to the main frame 310 so that the other end portion of the bar 110 is supported on the bar support portion 314 of the main frame 310. The second posture fixture 321 may have a shape that protrudes downward from the bracket 320 to engage with the concave groove 111 in the other end portion of the bar 110. Meanwhile, in the drawing, although the second posture fixture 321 is shown to have a shape corresponding to the shape of the concave groove 111 to engage with most of the concave groove 111, the idea of the present disclosure is not limited thereto. Like the first posture fixture 311, the second posture fixture 321 may be formed relatively small to be inserted into the concave groove 111 at a position spaced apart from the center of the bar 110.

The cover frame 330 may be detachably coupled to the main frame 310 and may support the bar 110 and the wire 200 together with the main frame 310. The cover frame 330 may include a plurality of protrusions formed to support upper sides of both end portions of the bar 110 when both end portions of the bar 110 are respectively fixed to the first posture fixture 311 and the second posture fixture 321.

Hereinafter, the operation and effects of the plasma filter 1 having the above-described configurations will be described.

After inserting the bar 110 into the tube 120, the bar assembly 100 is placed on the main frame 310 in a state in which the cover frame 330 and the bracket 320 are separated from the main frame 310. For example, when the first posture fixture 311 is inserted into the concave groove 111 formed in one end portion of the bar 110, one end portion of the bar 110 is seated on the bar seating portion 312. Then, the other end portion of the bar 110 is supported on the bar support portion 314. Further, when the bracket 320 is coupled to the main frame 310, the second posture fixture 321 of the bracket 320 is inserted into the concave groove 111 formed in the other end portion of the bar 110. Then, the cover frame 330 is coupled to the main frame 310. As a result, both ends of the bar 110 can be fixed to the frame assembly 300.

As such, the plasma filter according to the present disclosure is provided with the first posture fixture 311 and the second posture fixture 321 for fixing both end portions of the bar 110 to the frame assembly 300, so that the posture of the bar 110 can be prevented from changing due to external vibration while the bar 110 is placed in the frame assembly 300. Accordingly, the separation distance between the bar 110 and the wire 200 is maintained fixed, so that plasma generation efficiency by electrical interaction between the bar 110 and the wire 200 can be increased.

In addition, the concave groove 111 is formed in the bar 110, and the first posture fixture 311 of the main frame 310 and the second posture fixture 321 of the bracket 320 are respectively inserted into the concave groove 111 in both end portions of the bar 110, so that the bar 110 can be stably fixed to the frame assembly 300.

Further, the bar 110 may include the base portion 112, the side portion 113, and the connection portion 114 that form the concave groove 111, and the connection portion 114 may be formed in a curved shape. Accordingly, the bar 110 can be easily inserted into the tube 120, and the tube 120 can be prevented from being damaged when the bar 110 is inserted into the tube 120.

In addition, the base portion 112, the side portion 113, and the connection portion 114 of the bar 110 are disposed at positions spaced apart from the center of the bar 110, so that the concave groove 111 can be formed to be offset from the center of the bar 110. Accordingly, the material weight of the bar 110 itself can be reduced, which reduces the manufacturing cost of the bar 110.

Further, the bar 110 is inserted into the tube 120 so that the outer peripheral surface of the bar 110 is surrounded, so that the emission of ozone harmful to the human body, which may be generated from the bar 110 when plasma is generated by the electrical interaction of the bar 110 and the wire 200, can be reduced.

Moreover, the plurality of bars 110 and the plurality of wires 200 are alternately arranged at a predetermined distance from each other when viewed from above, so that plasma generation efficiency due to the electrical interaction between the plurality of bars 110 and the plurality of wires 200 can be increased.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A plasma filter comprising:
a bar assembly including a bar extending in a longitudinal direction;
a wire installed spaced apart from the bar to generate plasma between the bar and the wire when power is applied thereto; and
a frame assembly on which the bar and the wire are supported,
wherein a posture fixture is formed in the frame assembly to fix one or more of both end portions of the bar to prevent a posture of the bar from changing.

2. The plasma filter of claim 1, wherein the bar includes a concave groove extending in the longitudinal direction and recessed from an outer peripheral surface of the bar toward a center of the bar, and
wherein the posture fixture is inserted into the concave groove to be eccentric to the center of the bar.

3. The plasma filter of claim 1, wherein the frame assembly includes:
a main frame on which the bar and the wire are supported; and
a bracket detachably coupled to the main frame and fixing the bar to the main frame, and
wherein the posture fixture includes:
a first posture fixture formed on the main frame to fix one end portion of the bar; and
a second posture fixture formed on the bracket to fix the other end portion of the bar.

4. The plasma filter of claim 3, wherein the first posture fixture is inserted into the groove at a position spaced apart from the center of the bar.

5. The plasma filter of claim 3, wherein the second posture fixture has a shape that protrudes downward from the bracket to engage with the other end of the bar.

6. The plasma filter of claim 1, wherein the bar includes:
a base portion;
a side portion extending in a direction offset from the base portion to form the concave groove; and
a connection portion connecting the base portion and the side portion, and
wherein the connection portion is formed in a curved shape.

7. The plasma filter of claim 6, wherein at least one of the base portion, the side portion, and the connection portion is disposed at a position spaced apart from the center of the bar.

8. The plasma filter of claim 3, wherein the main frame includes a bar seating portion on which one end portion of the bar is seated, and
the bar seating portion is arranged to be spaced a predetermined distance lower than the first posture fixture when the main frame is placed horizontally.

9. The plasma filter of claim 8, wherein the bar assembly further includes a tube surrounding a portion of the bar,
the main frame further includes a tube support portion for supporting the tube, and
the tube support portion is disposed lower than the bar seating portion when the main frame is placed horizontally.

10. The plasma filter of claim 1, wherein the bar includes a plurality of bars and the wire includes a plurality of wires, and
wherein the plurality of bars and the plurality of wires are arranged to alternate with each other when viewed from above.
